(19) United States
(12) Patent Application Publication
(10) Pub. No.: US 2023/0381736 A1
(43) Pub. Date: Nov. 30, 2023

(54) COMPOSITE MATERIAL AND PROCESS FOR EXTRACTING LITHIUM USING THE SAME

(71) Applicant: GEOLITH, ORSAY (FR)

(72) Inventors: GUILLAUME GROS, CHEVAIGNÉ (FR); GHIZLÈNE ZENASNI, BAGNOLET (FR); DIDIER MUSCHALLE, COLMAR (FR); JEAN-PHILIPPE GIBAUD, LA CELLE SAINT-CLOUD (FR)

(21) Appl. No.: 18/032,814

(22) PCT Filed: Oct. 14, 2021
(86) PCT No.: PCT/EP2021/078465

§ 371 Date: Apr. 20, 2023

(30) Foreign Application Priority Data
Oct. 23, 2020 (EP) 20306275.7

(51) Int. Cl. B01J 20/04; B01J 20/28; B01J 20/34; B01J 20/30; B01J 20/06; C22B 26/12; C22B 3/42; C22B 3/10

(52) U.S. Cl. CPC B01J 20/041; B01J 20/2803; B01J 20/28088; B01J 20/28011; B01J 20/28004; B01J 20/3475; B01J 20/3433; B01J 20/3078; B01J 20/3085; B01J 20/06; C22B 26/12; C22B 3/42; C22B 3/10; B01J 2220/62

(57) ABSTRACT

The invention relates to composite material comprising polymer microfibers and lithium-adsorbent particles characterized in that said polymer microfibers have a diameter comprised between 10 μm and 500 μm, and said composite material has an open porosity comprised between 70% and 99% and a density comprised between 0.05 g/cm³ and 0.5 g/cm³. It also relates to a cartridge comprising such a material and to a process for extracting lithium from a brine using such a material.

### TECHNICAL FIELD

The invention relates to the field of lithium extraction. More specifically, the invention relates to a particular composite material comprising polymer microfibers and lithium-adsorbent particles, and to a cartridge comprising the same. It also relates to a process for extracting lithium from a brine using such a material.

### TECHNICAL BACKGROUND

Lithium is a critical element for the manufacture of batteries and various other applications. This element is nowadays extracted either from lithiniferous rocks or brines. These are composed of a large amount and variety of ions, such as sodium, magnesium, and calcium, which make it difficult to extract lithium. Current methods for extracting lithium from these brines are based on the successive precipitations of the various elements present until a lithium-rich solution is recovered. This solution can then be refined and finally precipitated in the form of hydroxide or carbonate by adding various reagents. These methods suffer however from several drawbacks. They indeed require very specific meteorological conditions, large surfaces and process times of 12 to 24 months. Also, their environmental footprint is disastrous, especially for the aquifer. Various alternative solutions are currently in development, in particular processes known as Direct Lithium Extraction (DLE) processes. These processes are not only developed to replace the standard techniques of precipitation, but also to favor the exploitation of brines which are not economically viable with the standard techniques. In particular, brines having low lithium concentrations, some waters from oil production, or some sources of geothermal water cannot be used today.

In order to increase the performances of the DLE processes, a wide diversity of materials, mostly composite materials, have been developed over the last few years.

Lawagon et al. (J. Ind. Eng. Chem. 2019, 70, 124-135) describe a material formed by electrospinning of a mixture comprising a polymer and particles of Li₂TiO₃. More specifically, the material consists of polymer nanofibers having an average diameter of 150 to 260 nm, and particles of Li₂TiO₃, or H₂TiO₃ after acid activation, distributed within the nanofibers and on their surface. However, nanofibers are highly flexible and tend to agglomerate, thereby making the material tight and subject to clogging.

US 2019/275473 describes a process for extracting lithium from a brine, wherein a membrane material comprising a porous support and a sorbent material is used. The sorbent material can in particular consist of lithium manganate, lithium titanate, or lithium aluminate particles, which can be distributed on the external surface of, and optionally within, the porous support. The porous support is in particular a flat membrane, a fiber, or a tubular structure, formed from a polymer or from an inorganic component. However, membrane materials are fragile, and are subject to clogging, which thus require pre-filtrations.

Although such materials can effectively extract lithium from brines, they are not designed or adapted to be inserted into water treatment devices, which subject the materials to high temperatures, pressures and flow rates.

Thus, there remains a need to provide a material having a high mechanical strength and showing no or low pressure loss, such that the material can be inserted into water treatment devices and withstand high temperatures, pressures and flow rates.

### SUMMARY OF THE INVENTION

In this respect, the inventors have developed a composite material comprising polymer microfibers and lithium-adsorbent particles, which meets the above requirements. The polymer microfibers have a diameter comprised between 10 μm and 500 μm, and the composite material has a density comprised between 0.05 g/cm³ and 0.5 g/cm³, and an open porosity comprised between 70% and 99%. Such features provide an optimal mechanical strength, and allow an insertion into water treatment devices without or with low pressure loss. The material can be prepared according to simple methods, the conditions of which enable to control the distribution of the particles within and/or on the surface of the microfibers.

The inventors have also shown that the material of the invention can effectively extract lithium contained in brines in high selectivity, typically by flowing the brine through the composite material. Lithium can be recovered and concomitantly, the material can be recycled, by merely using an acidic solution.

Thus, the present invention relates to a composite material comprising polymer microfibers and lithium-adsorbent particles, characterized in that:
said polymer microfibers have a diameter comprised between 10 μm and 500 μm;
said composite material has an open porosity comprised between 70% and 99%; and
said composite material has a density comprised between 0.05 g/cm³ and 0.5 g/cm³.

It also relates to a cartridge comprising such a composite material.

It also relates to a process for extracting lithium from a brine comprising the steps of:
(o) optionally, contacting a composite material as defined herein with an acid solution so as to obtain an activated composite material;
(a) contacting a composite material as defined herein or the activated composite material of step (o) with a brine comprising lithium, so as to obtain a lithium-loaded composite material;
(b) contacting said lithium-loaded composite material obtained in step (a) with an acid solution so as to obtain a lithium-containing solution and a lithium-unloaded composite material; and
(c) separating said lithium-containing solution and said lithium-unloaded composite material obtained in step (b).

It further relates to the use of a composite material as defined herein or a cartridge as defined herein, for extracting lithium from a brine.

### BRIEF DESCRIPTION OF THE FIGURES

FIG. 1: Schematic representation of a composite material of the invention rolled up (right) and a cartridge comprising the same (left).

FIG. 2: Schematic representation of a composite material of the invention rolled around a hollow perforated plastic cylinder (right) and a cartridge comprising the same (left).

### DETAILED DESCRIPTION OF THE INVENTION

In the following description, the expression “comprised between” is intended to include the upper and lower limits within the range described.

The material of the present invention is a composite material. It comprises, preferably consists of, polymer microfibers and lithium-adsorbent particles.

As used herein, “lithium-adsorbent particles” (or “L.A.P.”) refers to particles made of a material which is able to selectively adsorb (or capture) lithium ions contained in a brine.

The lithium selectivity of the lithium-adsorbent particles can be characterized in that the equilibrium constant of lithium capture by the lithium-adsorbent particles (K_{Li}; reaction (1)) is higher than the equilibrium constants of capture of the other cations or elements (i.e. “Mⁿ⁺” where n is an integer typically comprised between 0 and 6) present in the brine (K_{M}'s; reaction (2)), such as sodium, potassium, magnesium, calcium, strontium, or boron.

$${Li}^{+} + L . A . P {⇌}^{{K}_{Li}} {Li}^{+} - L . A . P \qquad ( 1 )$$

$${M}^{n +} + L . A . P {⇌}^{{K}_{M}} {M}^{n +} - L . A . P \qquad ( 2 )$$

In a particular embodiment, K_{Li} is at least 5 times, 10 times, 50 times, 100 times, or 500 times higher than each of the K_{M}'s.

In particular, the adsorbing properties of the material can refer to its ion-exchange or intercalation abilities. Various materials having such properties are known to the skilled artisan. The material of the lithium-adsorbent particles may typically include a combination of lithium (i.e., as lithium ions), metal atoms (i.e., other than lithium, typically in a cationic state, such as boron, aluminum, gallium, silicon, indium, titanium, vanadium, chromium, manganese, iron, cobalt, nickel, copper, stain, antimony, or zinc), oxygen atoms, and optionally, at least one anionic species selected from halide (e.g., fluoride, chloride, bromide, or iodide), nitrate (NO₃⁻), sulfate (SO₄²⁻), carbonate (CO₃²⁻), and bicarbonate (HCO₃⁻), all in a framework structure. The oxygen atoms may, in particular, be in the form of oxide ions (O²⁻⁾, as in a zeolitic structure. In other embodiments, the oxygen atoms are present as hydroxide (HO⁻) groups, or as both oxide and hydroxide groups, as in aluminum hydroxide, aluminum oxyhydroxide, and aluminosilicate structures (e.g., kaolinite). In the above material, the lithium may be partially or totally replaced with hydrogen. The term “framework structure,” as used herein and as well recognized in the art, refers to a network structure (e.g., one-, two-, or three-dimensional) in which components or elements in the structure are interconnected by, for example, covalent and/or ionic bonds. The oxygen atoms, whether as oxide or hydroxide groups, are typically bound to at least the metal atom(s) in such structures.

In a particular embodiment, the lithium-adsorbent particles are lithium manganate (also named “lithium manganese oxide” or “LMO”) particles, lithium titanate (also named “lithium titanium oxide” or “LTO”) particles, particles made of a lithium intercalate material, in particular lithium aluminate such as double hydroxide of aluminum and lithium halide (e.g. LiCl·2Al(OH)₃), or a mixture thereof. In a more particular embodiment, the lithium-adsorbent particles are lithium manganate particles, lithium titanate particles or a mixture thereof.

LMO, LTO, and lithium aluminate materials, and their preparation processes, are described, in particular, in the following publications: L. Li et al., Johnson Matthey Technol. Rev., 2018, 62, 161-176, V. P. Isupov, Journal of Structural Chemistry, 1999, 40, 672-685, Liu et al., Hydrometallurgy, 2019, 187, 81-100, Kotsupalo et al. Russian Journal of Applied Chemistry 2013, 86, 482-487, Ryabtsev et al. Russian Journal of Applied Chemistry 2002, 75, 1069-1074.

Examples of lithium titanate particles include, but are not limited to, LiTiO₂, Li₂TiO₃, Li₄TiO₄, Li₄Ti₁₁O₂₄, or Li₄Ti₅O₁₂ particles, or a mixture thereof.

Examples of lithium manganate particles include, but are not limited to, Li₄Mn₅O₁₂, LiMnO₂, Li₂MnO₂, LiMn₂O₄, Li₂Mn₂O₄, Li_{1.6}Mn_{1.6}O₄, or Li₂MnO₃ particles, or a mixture thereof.

In another particular embodiment, the lithium-adsorbent particles are particles of a mixed oxide or phosphate of lithium and at least one metal selected from stain, copper, antimony, vanadium, silicon, and iron. Examples of such mixed oxides or phosphates include, but are not limited to, Li₂SnO₃, LiCuO₂, Li₃VO₄, Li₂Si₃O₇, or LiFePO₄.

In another particular embodiment, the lithium-adsorbent particles are particles of H₂TiO₃.

In a preferred embodiment, said lithium-adsorbent particles are lithium titanate particles, more preferably Li₂TiO₃ particles or Li₄Ti₅O₁₂—Li₂TiO₃ particles, even more preferably Li₂TiO₃ particles.

The lithium-adsorbent particles may have a mean diameter comprised between 10 nm and 10 μm, for instance between 20 nm and 50 nm, or between 50 nm and 500 nm, or between 100 nm and 10 μm.

In a preferred embodiment, the lithium-adsorbent particles have a mean diameter comprised between 20 nm and 150 nm.

The standard deviation of particle diameters is advantageously less than or equal to 25%, preferably less than or equal to 20%, more preferably less than or equal to 10%. The distribution of particle diameters may be unimodal or multimodal, preferably unimodal.

The mean diameter of the particles, standard deviation and diameters distribution can be determined, in particular, by statistical studies of microscopy images, for example, those generated by scanning electron microscopy (SEM) or transmission electron microscopy (TEM).

The lithium-adsorbent particles are advantageously crystalline. For instance, Li₂TiO₃ particles can in particular be crystallized in monoclinic or cubic phase, preferably in monoclinic phase.

The lithium-adsorbent particles may be of any shape, for instance spherical, rod-shaped, star-shaped, triangle-shape, square-shaped, or pyramid-shaped.

Advantageously, the lithium-adsorbent particles are in the form of agglomerates. The term “aggregates” may be used equivalently to “agglomerates”. Said agglomerates preferably have a size comprised between 1 μm and 500 μm, preferably between 10 μm and 150 μm. The size of an agglomerate can in particular be determined by statistical studies of microscopy images, for example, those generated by scanning electron microscopy (SEM) or transmission electron microscopy (TEM).

The lithium-adsorbent particles can be prepared by any suitable process known to the skilled artisan, such as processes described in the aforementioned publications. The lithium-adsorbent particles may in particular be prepared by a hydrothermal method, or a solid-state method.

In a particular embodiment, the lithium-adsorbent particles are Li₂TiO₃ or Li₄Ti₅O₁₂—Li₂TiO₃ particles and the process for preparing these particles comprises the steps of:
(i) contacting titanium oxide (TiO₂) with lithium hydroxide (LiOH) aqueous solution at a temperature comprised between 80° C. and 150° C.; and,
(ii) optionally heating particles obtained in step (i) at a temperature comprised between 600° C. and 800° C.

In step (i) of such process, the concentration of LiOH in the LiOH aqueous solution is advantageously comprised between 5 mol/L and 10 mol/L.

The molar ratio of TiO₂ to LiOH and the duration of step (i) can be adjusted by the skilled artisan so as to control the formation of Li₂TiO₃ or Li₄Ti₅O₁₂—Li₂TiO₃ particles.

For instance, for preparing Li₂TiO₃ particles, the molar ratio of TiO₂ to LiOH in step (i) of such process is advantageously comprised between 0.05 and 0.2.

In another particular embodiment, the lithium-adsorbent particles are Li₂TiO₃ particles and the process for preparing these particles comprises the step of heating a solid mixture comprising titanium oxide (TiO₂) and lithium carbonate (Li₂CO₃) at a temperature comprised between 600° C. and 800° C.

In such process, the molar ratio of TiO₂ to Li₂CO₃ is advantageously comprised between 0.9 and 1.1.

The lithium adsorbent particles described above are used in combination with polymer microfibers which will now be described, to form the composite material of this invention. Due to its open porosity, the composite material typically acts as a supporting porous media and not as a barrier, such as membranes. The resistance of such supporting porous media to the fluid passage is advantageously null or as low as possible.

The diameter of the polymer microfibers is comprised between 10 μm and 500 μm, for instance between 15 μm and 50 μm, or between 250 and 450 μm. Preferably, the diameter of the polymer microfibers is comprised between 20 μm and 350 μm, more preferably between 50 μm and 150 μm.

In a particular embodiment, at least 80%, 90%, 95%, 98% or 99% of the polymer microfibers of the material of the invention have substantially the same diameter. The expression “substantially the same diameter” means that said diameter varies by ±15%, preferably ±10%.

The diameter of the polymer microfibers can be determined, in particular, by statistical studies of microscopy images, for example, those generated by scanning electron microscopy (SEM) or transmission electron microscopy (TEM).

The shape of the cross section of the polymer microfibers, may for instance be circular, trilobal, quadrilobal, or multilobal, preferably circular.

When a cross-section of a polymer microfiber is not circular (for instance, trilobal, quadrilobal, or multilobal), the “diameter” as used herein is considered as the longest dimension of the cross-section.

The polymer microfibers may be made of any organic or silicon-based, preferably organic, polymer material. Such polymer material has advantageously no or low ion-exchange properties, and can be resistant to temperatures up to 90° C. and resistant to acidic and basic pH's.

In a particular embodiment, the polymer of the polymer microfibers is chosen from polypropylene (PP), polystyrene, polyethylene (PE, such as high-density polyethylene), polyvinyl chloride, a fluoropolymer (such as polyvinyl fluoride, polyvinylidene fluoride (PVDF), polytetrafluoroethylene (PTFE)), polyvinyl alcohol, polyacrylic acid, polymethacrylic acid, polyacrylamide, polyacrylonitrile, polyether imine, polyether ketone ketone (PEKK), polyether ether ketone (PEEK), polyesters (PEs, such as polyglycolic acid, polylactic acid, polycaprolactone, polyhydroxyalcanoate such as polyhydroxybutyrate, polyethylene adipate, polyethylene succinate, polyethylene terephthalate, polybutylene terephthalate, polyethylene naphtalate), polyamides (such as polycaprolactame, polylauroamide, polyundecanamide, polytetramethylene adipamide, polyhexamethylene adipamide, polyhexamethylene nonanediamide, polyhexamethylene sebacamide or polyhexamethylene dodecanediamide), polysiloxane, a copolymer thereof, or a mixture thereof.

A preferred polyester is polyethylene terephthalate (PET).

In a more particular embodiment, the polymer of the polymer microfibers is polypropylene, a combination of polyester and polyethylene (also named herein “PEs-PE”), or a combination of polyethylene and polypropylene (also named herein “PE-PP”), polyethylene terephthalate, polypropylene, polystyrene, polyethylene, or a mixture thereof.

In a preferred embodiment, the polymer of the polymer microfibers is polypropylene, a combination of polyester and polyethylene (also named herein “PEs-PE”), or a combination of polyethylene and polypropylene (also named herein “PE-PP”), or a mixture thereof.

In another preferred embodiment, the polymer of the polymer microfibers is polyethylene terephthalate, polypropylene, polystyrene, polyethylene, or a mixture thereof, more preferably polyethylene terephthalate, polypropylene or a mixture thereof, even more preferably polypropylene.

The polymer microfibers may be hollow or solid, preferably solid.

In a particular embodiment, the polymer microfibers have a core-shell structure. In such an embodiment, the polymer of the core and the polymer of the shell may be chosen from the above polymers, and may be identical or different.

In a particular embodiment, the polymer microfibers are made of a combination of PEs and PE polymers, and has a core-shell structure, wherein the shell is made of polyethylene and the core is made of polyester.

In another particular embodiment, the polymer microfibers are made of a combination of PE and PP polymers, and has a core-shell structure, wherein the shell is made of polyethylene and the core is made of polypropylene.

The polymer microfibers can be assembled to form a woven, non-woven, loose, coiled, or 25 entangled structure, such as a non-woven fabric, a woven fabric, or a mat, preferably a non-woven fabric.

In a particular embodiment, the weight ratio of said lithium-adsorbent particles to said polymer microfibers is comprised between 0.05 and 5, for instance between 0.05 and 2, or between 0.1 and 2, or between 0.5 and 1.5.

In a particular embodiment, the composite material of the invention further comprises a binder.

In a more particular embodiment, the composite material consists of said polymer microfibers, said lithium-adsorbent particles, and a binder. The binder may advantageously be used to enhance binding between the polymer microfibers and the lithium-adsorbent particles. Such binder is advantageously made of at least one polymer material, which may be chosen from the above polymers. The binder and the polymer microfibers in a composite material are typically different in that the binder has a lower melting point than the polymer microfibers. The binder may be used in the form of microfibers or powder. When the binder is a microfiber having a core-shell structure, the melting point of the shell has typically a lower melting point than the polymer microfibers of the composite material. In a particular embodiment, the polymer of the binder is polypropylene or a combination of polyethylene and polyethylene terephthalate (also named herein “PE-PET”). In an embodiment where the binder is PE-PET, such binder may be in the form of a core-shell microfiber wherein the core is made of polyethylene terephthalate and the shell is made of polyethylene.

When the binder is microfibers, the diameter of the binder microfibers can be comprised between 10 μm and 500 μm, for instance between 15 μm and 50 μm, or between 250 and 450 μm, as determined by SEM or TEM. Preferably, at least 80%, 90%, 95%, 98% or 99% of the microfibers used as binder have substantially the same diameter.

The weight ratio of said binder to said polymer microfibers may be comprised between 0.01 and 2, for instance between 0.05 and 1, or between 0.3 and 0.6.

In a particular embodiment, the polymer of the polymer microfibers and the polymer of the binder are polypropylene.

In another particular embodiment, the polymer of the polymer microfibers is polypropylene and the polymer of the binder is PE-PET.

The lithium-adsorbent particles can be distributed within and/or on the surface of the polymer microfibers. Preferably, the lithium-adsorbent particles are distributed on the surface of the polymer microfibers, and optionally within the polymer microfibers.

In a particular embodiment, the polymer microfibers have a core-shell structure, and lithium-adsorbent particles are distributed within and/or on the surface of the shell of the polymer microfibers.

As detailed below, the distribution of the lithium-adsorbent particles can be controlled by adjusting the conditions of the process for preparing the composite material of the invention.

The material of the invention may have any form, this form being usually chosen according to the intended application. In particular, the composite material may have any form wherein the polymer microfibers are woven, non-woven, loose, coiled, or entangled. In a particular embodiment, the composite material can be a woven material (or fabric) or a non-woven material (or fabric).

In a preferred embodiment, the composite material is in the form of a non-woven fabric. Said nonwoven fabric may advantageously have a basis weight comprised between 100 and 800 g/m² (preferably between 400 and 600 g/m²). Said nonwoven fabric may in particular have a thickness from 1 to 10 mm, preferably from 2 to 4 mm. As used herein, the “basis weight” corresponds to the weight/surface ratio of the non-woven fabric, and can be measured by any suitable technique known to the skilled artisan, for instance by means of a weight gauge or by measuring the weight of a 1 square meter surface of non-woven fabric. The thickness can be measured by any suitable technique known to the skilled artisan, such as the use of a fabric thickness gauge.

The composite material of the invention has a density comprised between 0.05 g/cm³ and 0.5 g/cm³, preferably between 0.1 and 0.3 g/cm³, more preferably between 0.15 and 0.3 g/cm³. As used herein, the “density” refers to an apparent density and corresponds to the weight/volume ratio of the composite material of the invention. The density can be measured by any suitable techniques known to the skilled artisan, for instance by means of pycnometer. The density can also be calculated based on the basis weight and the thickness, or by measuring the weight of material comprised in a known volume.

Furthermore, said composite material has an open porosity comprised between 70% and 99%, preferably between 80 and 90%. As used herein, the open porosity is defined as the ratio of accessible pore volume to the total volume of the composite material. The open porosity (P) is defined according to the following equation (1):

P=(V₁/V₂)×100% (1),
wherein:
V₁ is the accessible pore volume,
V₂ is the volume of the composite material.

The open porosity can be measured by pressure difference or fluid saturation methods. Such methods are in particular described in the following publications: Champoux et al. J. Acoust. Soc. Am. 1991, 89, 910-916, Salissou et al. J. Appl. Phys. 2007, 101, 124913.

Advantageously, the density and the open porosity of the material of the invention allows a brine to pass through the material of the invention, without substantial pressure loss.

Process for Preparing the Material of the Invention

Generally speaking, the composite material of the present invention can be prepared according to a process comprising:
(A) preparing or providing polymer microfibers having a diameter comprised between 10 μm and 500 μm, and
(B) shaping said polymer microfibers under conditions allowing to obtain the composite material of the invention,
wherein lithium-adsorbent particles are added in step (A), between step (A) and step (B), or after step (B).

Conditions of the process, and in particular the step of adding of the lithium-adsorbent particles, can be adjusted so as to control the distribution of the lithium-adsorbent particles within and/or on the surface of the polymer microfibers, and the characteristics (in particular, the density and the open porosity) of the material of the invention. A binder made of a polymer material, which may be in microfiber or in powder form, may be added in, before, or after steps (A) and/or (B). The binder and the polymer microfibers in a composite material are typically different in that the binder has a lower melting point than the polymer microfibers, such that a heating step at a temperature comprised between the melting point of the binder and that of the polymer microfibers allows to fuse the binder (or part of the binder, such as the shell of a core-shell microfiber binder) only. According to the present invention, the shaping of the polymer microfibers refers, in particular, to the formation of a plurality of polymer microfibers, into a material. For instance, the shaping of the polymer microfibers can comprise converting polymer microfibers into a nonwoven material, such as a nonwoven fabric.

In a first embodiment, polymer microfibers are provided or prepared, and then shaped into a nonwoven material (e.g. a nonwoven fabric) before the addition of lithium-adsorbent particles.

The polymer microfibers can be prepared and shaped by any suitable method known to the skilled artisan, such as spinning methods. For instance, polymer microfibers can be obtained by a method comprising:
heating a polymer, which may be in the form of a powder, pellets or granules, and
passing said polymer through a die (or a nozzle), for example using at least one piston or continuous twin-screw or single-screw extruder.

The diameter of the die (or nozzle) and the diameter of the polymer microfibers obtained are substantially the same. The shape of the die (or nozzle) and consequently, that of the cross section of polymer microfibers, may for instance be circular, trilobal, quadrilobal, or multilobal, preferably circular.

The resulting polymer microfibers can then be shaped into a nonwoven material (e.g. a nonwoven fabric) by any suitable method known to the skilled artisan, such as felting methods.

For instance, the shaping of the polymer microfibers into a nonwoven material or fabric can in particular be carried out by shredding, felting, or needling.

The lithium-adsorbent particles can then be sprinkled on the resulting nonwoven material and be distributed within the material by any suitable method known to the skilled artisan. A calendering step is preferably carried out after the shaping step. Such calendering step allows to bind the polymer microfibers and lithium-adsorbent particles.

In such first embodiment, the lithium-adsorbent particles are typically distributed on the surface of the polymer microfibers.

In a second embodiment, polymer microfibers are provided or prepared, and then mixed with lithium-adsorbent particles. The polymer microfibers can be prepared by any suitable method known to the skilled artisan, such as spinning methods. For instance, polymer microfibers can be obtained by a method comprising:
heating a polymer, which may be in the form of a powder, pellets or granules, and
passing said polymer through a die (or a nozzle), for example using at least one piston or continuous twin-screw or single-screw extruder.

The diameter of the die (or nozzle) and the diameter of the polymer microfibers obtained are substantially the same. The shape of the die (or nozzle) and consequently, that of the cross section of polymer microfibers, may for instance be circular, trilobal, quadrilobal, or multilobal, preferably circular.

The mixing of polymer microfibers with lithium-adsorbent particles can for instance be carried out by air-blowing. The resulting mixture can then be shaped into a nonwoven material (e.g. a nonwoven fabric) by any suitable method known to the skilled artisan, such as shredding, felting, or needling. Also, a calendering step is preferably carried out after the shaping step.

Such calendering step allows to bind the polymer microfibers and lithium-adsorbent particles.

In such second embodiment, the lithium-adsorbent particles are typically distributed on the surface of the polymer microfibers.

In a third embodiment, lithium-adsorbent particles and a first polymer are mixed and extruded into a compounding material, typically in the form of powder, pellets or granules. The compounding material and a second polymer, typically in the form of powder, pellets or granules, are converted, by means of a double perpendicular extruder apparatus, into core/shell polymer microfibers with a core consisting of the second polymer and a shell consisting of a mixture of the first polymer and the lithium-adsorbent particles. The polymer microfibers can then be shaped into a nonwoven material (e.g. a nonwoven fabric). The shaping of the polymer microfibers into a nonwoven material or fabric can in particular be carried out by shredding, felting, or needling.

In such third embodiment, the lithium-adsorbent particles are typically distributed within the shell of the polymer microfibers.

Alternatively, in the above processes, a woven, loose, coiled, or entangled material can be produced in the shaping step, by any suitable technique known to the skilled artisan.

Assemblies can be formed by combining one or more composite materials of the invention, identical or different (and optionally one or more additional materials), for instance by stacking.

For instance, such assembly can be formed of a layer of a non-woven composite material of the invention, sandwiched between two layers of non-woven fabric. In such embodiment, a calendering step is advantageously carried out after the stacking step, in order to bind the layers.

At least one composite material of the invention and a rigidity enhancer can be combined, so as to form an assembly comprising (or consisting of) at least one composite material of the invention and a rigidity enhancer. Such rigidity enhancer aims at improving the resistance of the material to deformation or compression that may be caused by high brine pressures. The rigidity enhancer is typically a grid, preferably a polymer grid. Such a grid may be deposited onto the polymer microfibers after the shaping step of the composite material. The polymer of a polymer grid may be chosen from the polymers mentioned above for the polymer microfibers.

At least one composite material of the invention and two layers of low porous low basis weight non-woven fabric (for instance Spunbond-type or Meltblow-type fabric) can be combined, so as to form an assembly comprising (or consisting of) at least one composite material of the invention sandwiched between two layers of low porous low basis weight non-woven fabric.

Such layers of low porous low basis weight non-woven fabric can be made of polypropylene fibers, and can have a basis weight between 25 and 40 g/m².

Such layers of low porous low basis weight non-woven fabric can act as enhancer of the retention of the lithium-adsorbent particles, and aims at improving the retention of the lithium-adsorbent particles over time ant therefore improving the duration of use of the composite material. Such layers of low porous low basis weight non-woven fabric may be deposited onto the polymer microfibers during or after the shaping step of the composite material.

Process for Extracting Lithium from a Brine:

Another object of the present invention is a process for extracting lithium from a brine (hereinafter, “extraction process”) comprising the steps of:
(o) optionally, contacting a composite material as defined herein with an acid solution so as to obtain an activated composite material;
(a) contacting a composite material as defined herein or the activated composite material of step (o) with a brine comprising lithium, so as to obtain a lithium-loaded composite material;
(b) contacting said lithium-loaded composite material obtained in step (a) with an acid solution so as to obtain a lithium-containing solution and a lithium-unloaded composite material; and
(c) separating said lithium-containing solution and said lithium-unloaded composite material obtained in step (b).

In the extraction process of the invention, the pressure loss induced by the composite material is advantageously below 0.5 bar, for instance between 0.01 bar and 0.5 bar, or between 0.05 bar and 0.2 bar.

As used herein, a “brine” can refer to any solution comprising at least one lithium salt and at least one additional alkali, alkaline earth metal, and/or transition metal salt(s) in water, wherein the concentration of salts can vary from trace amounts up to the point of saturation. Generally, brines suitable for the extraction process of the invention are aqueous solutions that may include alkali, alkaline earth metal, and/or transition metal chlorides, bromides, sulfates, hydroxides, nitrates, and the like, as well as natural brines. Exemplary alkali, alkaline earth metal, and/or transition metal which can be present in brines include, but are not limited to, sodium, potassium, calcium, magnesium, lithium, strontium, barium, iron, boron, silicon, manganese, zinc, aluminum, antimony, chromium, cobalt, copper, lead, arsenic, mercury, molybdenum, nickel, silver, gold, thallium, radon, cesium, rubidium, vanadium and their mixtures. Brines can be obtained from natural sources, such as Chilean brines, Argentinean brines, Bolivian brines, or Salton Sea brines, geothermal brines, sea water, salar brines, oilfield brines, mineral brines (e.g., lithium chloride or potassium chloride brines), alkali metal salt brines, and industrial brines, for example, industrial brines recovered from ore leaching, mineral dressing, and the like. The extraction process is also applicable to artificially prepared brine or salt solutions, as well as waste solutions such as waste water streams or waste solutions from lithium-ion batteries. In a particular embodiment, the brine is a geothermal brine, a salar brine, or an oilfield brine.

The lithium concentration in the brine can vary according to the nature or the origin of the brine. For instance, the mass concentration of lithium in the brine can be comprised between 10 ppm and 2000 ppm, preferably between 100 ppm and 500 ppm.

Optional step (o) may be implemented before step (a) to activate the composite material. The terms “activate” or “activation” are used herein to denote an improvement of the reactivity of the composite material, or an improvement of its ion-exchange or intercalation abilities. Said activation step (o) comprises contacting the composite material of the invention with an acid solution.

The acid solution is typically an aqueous solution comprising at least one organic or inorganic acid. It is preferred that the acid solution is substantially deprived of salts, in particular alkali, alkaline-earth metal, or transition metal salts. Examples of acid which can be used in step (o) include, but are not limited to, hydrochloric acid, hydrobromic acid, hydroiodic acid, sulfuric acid, nitric acid, phosphoric acid, formic acid, acetic acid, trifluoroacetic acid, methanesulfonic acid, benzenesulfonic acid or p-toluenesulfonic acid. Preferably, the acid solution is a hydrochloric acid (HCl) aqueous solution.

In a particular embodiment, the acid solution further comprises at least one lithium salt. In such embodiment, the lithium-adsorbent particles of the composite material are advantageously particles made of lithium intercalate material. Examples of lithium salt include, but are not limited to, the lithium salts of the above acids, lithium hydroxide, or lithium carbonate. In another particular embodiment, the acid solution further comprises a lithium-containing solution obtained in step (c) of a previous extraction process according to the invention.

Alternatively, the acid solution in step (o) can be an aqueous solution wherein protons (H⁺) are produced by electrolysis or electrodialysis.

In a particular embodiment, the concentration of the acid solution in step (o) is comprised between 0.05 mol/L and 2 mol/L.

In a particular embodiment, the temperature of the acid solution in step (o) is comprised between 5° C. and 90° C., for instance between 15° C. and 25° C., or between 60° C. and 80° C.

Preferably, step (o) comprises flowing said acid solution through said composite material of the invention. In such an embodiment, the pressure can be up to 60 bar, preferably between 1 bar and 5 bar.

In step (a) of the extraction process of the invention, the brine comprising the lithium to be selectively extracted is contacted with a composite material of the invention, or with the activated composite material of step (o).

In a preferred embodiment, step (a) comprises flowing said brine comprising lithium through said composite material of the invention or said activated composite material. In such an embodiment, the pressure can be up to 60 bar, for instance between 1 bar and 5 bar or between 20 bar and 45 bar.

In a particular embodiment, the temperature of the brine in step (a) is comprised between 5° C. and 90° C., for instance between 15° C. and 25° C., or between 60° C. and 80° C.

In a particular embodiment, the pressure in step (a) is comprised between 1 bar and 5 bar, and the temperature of the brine in step (a) is comprised between 15° C. and 25° C. In such embodiment, the brine may in particular be an oilfield brine or a salar brine.

In another particular embodiment, the pressure in step (a) is comprised between 20 bar and 45 bar, and the temperature of the brine in step (a) is comprised between 60° C. and 80° C. In such embodiment, the brine may in particular be a geothermal brine.

In a particular embodiment, a base or an acid, preferably a base, is added to the brine, before step (a) or in step (a) of the extraction process. This acid or base may in particular be used to adjust the pH of the brine and/or favor the lithium absorption by the composite material.

Examples of acid include, but are not limited to, hydrochloric acid, hydrobromic acid, hydroiodic acid, sulfuric acid, nitric acid, phosphoric acid, formic acid, acetic acid, trifluoroacetic acid, methanesulfonic acid, benzenesulfonic acid or p-toluenesulfonic acid.

Examples of base include, but are not limited to, ammonia, carbonates (such as sodium or potassium carbonate), hydrogenocarbonates (such as sodium or potassium hydrogenocarbonate), hydroxides (such as sodium or potassium hydroxide), or mono- or poly-carboxylates (such as acetate or citrate).

Alternatively, the pH of the brine can be adjusted before step (a) or in step (a) by an electrolysis or electrodialysis producing protons (H⁺) or hydroxide (HO⁻) (preferably hydroxide) in the brine.

The pH of the brine may be comprised between 3 and 12, preferably comprised between 7 and 10.

Step (a) of the extraction process allows the composite material, and more particularly the lithium-adsorbent particles thereof, to be loaded with the lithium of the brine. At the end of step (a), a residual brine is obtained. As used herein, the “residual brine” refers to the brine obtained after subjecting the brine comprising lithium to the contacting step (a). The concentration of lithium in the residual brine is typically lower than that of the brine. The residual brine and the lithium-loaded composite material are advantageously separated, and said lithium-loaded composite material is then subjected to step (b).

Step (b) comprises contacting the lithium-loaded composite material obtained in step (a) with an acid solution. The contacting step (b) is advantageously carried out under conditions allowing the release of the lithium extracted by the composite material.

In a preferred embodiment, step (b) comprises flowing said acid solution through said lithium-loaded composite material. In such an embodiment, the pressure can be up to 60 bar, preferably between 1 bar and 5 bar.

The acid solution is typically an aqueous solution comprising at least one organic or inorganic acid. It is preferred that the acid solution is substantially deprived of salts, in particular alkali, alkaline-earth metal, or transition metal salts. Examples of acid which can be used in step (b) include, but are not limited to, hydrochloric acid, hydrobromic acid, hydroiodic acid, sulfuric acid, nitric acid, phosphoric acid, formic acid, acetic acid, trifluoroacetic acid, methanesulfonic acid, benzenesulfonic acid or p-toluenesulfonic acid. Preferably, the acid solution is a hydrochloric acid (HCl) aqueous solution.

In a particular embodiment, the acid solution further comprises at least one lithium salt. In such embodiment, the lithium-adsorbent particles of the composite material are advantageously particles made of lithium intercalate material. Examples of lithium salt include, the lithium salts of the above acids, lithium hydroxide, or lithium carbonate. In another particular embodiment, the acid solution further comprises a lithium-containing solution obtained in step (c) of a previous extraction process according to the invention.

Alternatively, the acid solution in step (b) can be an aqueous solution wherein protons (H⁺) are produced by electrolysis or electrodialysis.

In a particular embodiment, the concentration of the acid solution in step (b) is comprised between 0.05 mol/L and 2 mol/L.

In a particular embodiment, the temperature of the acid solution in step (b) is comprised between 5° C. and 90° C., for instance between 15° C. and 25° C. or between 60° C. and 80° C.

Step (b) of the extraction process allows the release of the lithium loaded in the lithium-loaded composite material into the acid solution, such that a lithium-containing solution and a lithium-unloaded composite material are obtained.

It is understood that traces of lithium may be present in the lithium-unloaded composite material, and that traces of acid may be present in the lithium-containing solution. It is also understood that the lithium of the lithium-containing solution is typically in the form a salt solubilized in said solution.

In step (c) of the extraction process, said lithium-containing solution and said lithium-unloaded composite material are separated.

In a particular embodiment, the lithium-unloaded composite material is substantially similar to the composite material or the activated composite material used in step (a).

In a particular embodiment, the extraction process of the invention comprises a recycling step of the lithium-unloaded composite material obtained in step (c). In such an embodiment, the lithium-unloaded composite material obtained in step (c) is re-used in step (a) as a composite material for extracting lithium. The lithium-unloaded composite material may in particular be re-used in step (a) (or in other words, be recycled) from 100 to 10,000 times, preferably from 500 to 5,000 times.

In some embodiments, the residual brine obtained in step (a) still comprises lithium. The brine used in step (a) may thus comprise a residual brine obtained in step (a) of a previous extraction process according to the invention.

In a particular embodiment, the acid solution used in step (c) may comprise (or consist of) the lithium-containing solution obtained in step (c) of a previous extraction process according to the invention. In such embodiment, the pH of said acid solution comprising (or consisting of) the lithium-containing solution obtained in step (c) of a previous extraction process of the invention may be adjusted by adding an acid.

In a particular embodiment, the process comprises:
a washing step between step (o) and step (a), preferably comprising contacting a deionized water with (e.g. flowing said water through) the activated composite material; and/or
a washing step between step (a) and step (b), preferably comprising contacting a deionized water with (e.g. flowing said deionized water through) the lithium-loaded composite material; and/or
a washing step after step (c), preferably comprising contacting a deionized water with the lithium-unloaded composite material.

In a particular embodiment, the composite material used in the extraction process is in the form of a nonwoven fabric. Said nonwoven fabric may advantageously have a basis weight comprised between 100 and 800 g/m² (preferably between 400 and 600 g/m²). Said nonwoven fabric may in particular have a thickness from 1 to 10 mm, preferably from 2 to 5 mm.

The composite material may be inserted into a cartridge or a column, through which the brine comprising the lithium can flow. The composite material can in particular be rolled up or rolled around a rod or a perforated hollow cylinder, and inserted into said cartridge or column. The composite material is preferably a nonwoven material (or fabric). Alternatively, the composite can be a woven material, or any other material wherein the polymer microfibers are loose, coiled, or entangled. As mentioned above, at least one composite material of the invention and a rigidity enhancer can be combined, so as to form an assembly comprising (or consisting of) at least one composite material of the invention and a rigidity enhancer. Such rigidity enhancer (e.g. a grid) may be deposited onto the polymer microfibers after the shaping step of the composite material, and the resulting assembly may be rolled up or rolled around a rod or a perforated hollow cylinder, before being inserted into said cartridge or column.

In a preferred embodiment, the extraction process of the invention, and in particular optional step (o), and steps (a) and (b), are carried out in a single reactor, for instance, one or more cartridges or columns containing the composite material of the invention. In such an embodiment, the extraction process can be carried out under continuous or batch conditions, preferably continuous conditions. The extraction process of the invention, in particular each of steps (o), (a), and (b) independently, can be carried out in an open circuit or in a closed circuit. In a particular embodiment, optional step (o) and step (b) are carried out in an open circuit, and step (a) is carried out in an open or closed circuit. In an embodiment where step (a) is carried out in a closed circuit, the brine is contacted several times with the composite material (or the activated composite material of step (o)) cyclically.

In a particular embodiment, step (o) comprises:
injecting an acid solution through an inlet of a reactor, such as a cartridge or a column, containing the composite material of the invention,
flowing said acid solution through the composite material, and
recovering an activated composite material.

In such an embodiment, a residual acid solution is removed through an outlet of the reactor and the activated composite material remains in the reactor.

In another particular embodiment, step (a) comprises:
injecting a brine comprising lithium through an inlet of a reactor, such as a cartridge or a column, containing the composite material of the invention or the activated composite material,
flowing said brine comprising lithium through said composite material or said activated composite material, and
recovering a lithium-loaded composite material, and a residual brine.

In such an embodiment, said residual brine is removed through an outlet of the reactor and the lithium-loaded composite material remains in the reactor.

In another particular embodiment, step (b) comprises:
injecting an acid solution through an inlet of a reactor (such as a cartridge or a column), containing a lithium-loaded composite material, and
flowing said acid solution through said lithium-loaded composite material.

In such embodiment, the lithium-containing solution and the lithium-unloaded composite material can be separated (step (c)) by recovering the lithium-containing solution at an outlet of the reactor while the lithium-unloaded composite material remains in the reactor.

In such embodiment, the recycling can be carried out by re-injecting a brine comprising lithium through an inlet of a reactor containing the composite material.

The extraction process of the invention can in particular be implemented at a temperature comprised between 5° C. and 90° C., for instance between 15° C. and 25° C., or between 60° C. and 80° C. The duration of each of steps (o), (a) and (b) of the extraction process may independently be comprised between 10 min and 24 h. More particularly, the total duration of steps (o), (a) and (b) may be comprised between 1 h and 24 h, preferably between 2 h and 6 h.

The lithium of the lithium-containing solution, which is typically in the form a salt solubilized 15 in said solution, can then be converted into any solid material, such as Li₂CO₃, LiOH, LiCl or metal lithium, by any technique known to the skilled artisan.

Another object of the present invention is a cartridge comprising a composite material as defined herein.

Another object of the invention is a use of a composite material as defined herein for extracting lithium from a brine.

The invention will also be described in further detail in the following examples, which are not intended to limit the scope of this invention, as defined by the attached claims.

### EXAMPLES

### Example 1: Preparation of Lithium-Adsorbent Particles

a—Preparation of Li₂TiO₃ Particles

Method A

The Li₂TiO₃ particles were synthesized using hydrothermal synthesis from titanium dioxide and lithium hydroxide precursors in a molar ratio of 1:10 (TiO₂, LiOH). The titanium precursor 10 were added to a 7 mol/L solution of LiOH in water and the resulting mixture was heated up to 120° C. for 48 hours in a closed vessel and then cooled down to room temperature. The obtained powder was filtered and rinsed with water to yield Li₂TiO₃ particles. Powder XRD showed a Li₂TiO₃ in a cubic phase. The powder was then fired in a furnace with a heating rate of 5° C./min up to 700° C. for 4 hours and then cooled down to room temperature.

The resulting powder was analyzed by powder XRD and the monoclinic phase of Li₂TiO₃ was confirmed. MEB analysis showed cubic shaped nanoobjects sized from 20 nm to 50 nm. The nanoobjects are bound into agglomerates of sizes from 1 to 300 μm.

Method B

The Li₂TiO₃ particles were synthesized using a solid-state method from titanium dioxide and lithium carbonate precursors in a molar ratio of 1:1. The precursors were mixed together and the resulting mixture was fired in a furnace with a heating rate of 5° C./min up to 700° C. for 24 hours and then cooled down to room temperature.

The resulting powder was analyzed by powder XRD and the monoclinic phase of Li₂TiO₃ was confirmed. MEB analysis showed particles sized from 100 nm to 10 μm. These primary particles are bound into agglomerates of sizes from 1 to 500 μm.

b—Preparation of Mixed Li₄Ti₅O₁₂—Li₂TiO₃ Particles

The mixed Li₄Ti₅O₁₂—Li₂TiO₃ particles were synthesized using hydrothermal synthesis from titanium dioxide and lithium hydroxide precursors in a molar ratio of 1:2.2 (TiO₂, LiOH). The titanium precursor were added to a 7 mol/L solution of LiOH in water and the resulting mixture was heated up to 120° C. for 6 hours in a closed vessel and then cooled down to room temperature. The obtained powder was filtered and rinsed with water to yield mixed Li₄Ti₅O₁₂—Li₂TiO₃ particles. Powder XRD showed a 50:50 Li₄Ti₅O₁₂—Li₂TiO₃ phase. The powder was then fired in a furnace with a heating rate of 5° C./min up to 700° C. for 4 hours and then cooled down to room temperature.

MEB analysis showed cubic shaped nanoobjects sized from 20 nm to 50 nm. The nanoobjects are bound into agglomerates of sizes from 1 to 300 μm.

### Example 2: Preparation of the Composite Material

a—Powder Addition by Sprinkling Over an Existing Nonwoven Fabric

i) With a Polypropylene Nonwoven Fabric and Polypropylene Powder as a Binder

Li₂TiO₃ powder prepared according to the above methods A or B, and a low fusion temperature polypropylene (PP) powder used as binder (particle size between 0 and 170 μm, melting range 135-146° C.), were mixed together in a 60:40 weight ratio and sprinkled upon a polypropylene nonwoven fabric (fiber diameter 30 μm, basis weight 200 g/m², thickness 2.0 mm, melting range above 160° C.) to obtain 300 g/m² of total powder onto the nonwoven fabric. The resulting fabric was then subjected to vibration to allow distribution of the powder into the entire thickness of the nonwoven fabric. The fabric was then subjected to calendering to allow the PP powder to fuse at 146° C. and therefore bind the Li₂TiO₃ powder onto the PP fibers between them.

Characteristics of the obtained composite material:
Fibers with a diameter of around 30 μm (measured by statistical studies of SEM images)
Basis weight of around 500 g/m²
Thickness of around 2 mm
Density of around 0.2 g/cm³ (calculated by measuring the weight of material comprised in a 30 mL cartridge)
Open porosity of around 85% (measured by pressure difference)
Weight distribution of 180:120:200 of lithium-adsorbent particles:polymer binder:polymer microfibers
Temperature of use range: up to 100° C.

ii) With an Auto-Binding PEs-PE Nonwoven Fabric

Li₂TiO₃ powder prepared according to the above methods A or B, was sprinkled upon a polyester-PE nonwoven fabric (Core-Shell fibers with PE as the shell polymer, melting point of the shell at 127° C., diameter 30 μm fiber, basis weight 250 g/m², thickness 2.12 mm) to obtain 259 g/m² of total powder onto the nonwoven fabric. The resulting fabric was then subjected to vibration to allow distribution of the powder into the entire thickness of the nonwoven fabric. The fabric was then subjected to calendering to allow the PE core-shell to fuse at 146° C. and therefore bind the Li₂TiO₃ powder onto the fibers.

Characteristics of the Obtained Composite Material:
Fibers with a diameter of around 30 μm (measured by statistical studies of SEM images)
Basis weight of around 509 g/m²
Thickness of around 2 mm
Density of around 0.25 g/cm³ (calculated by measuring the weight of material comprised in a 30 mL cartridge)
Open porosity of around 85% (measured by pressure difference)
Weight distribution of 50:50 of lithium-adsorbent particles:polymer microfibers
Temperature of use range: up to 100° C.

b—Powder Addition During the Felting

i) With PP Fibers as the Matrix and PE-PET Fibers as a Binder

Li₂TiO₃ powder prepared according to the above methods A or B, PE-PET fibers (Core-Shell fibers with PE as the shell polymer, melting point of the shell at 127° C., diameter 10 μm) as a binder, and polypropylene fibers (melting point 160° C., diameter 20 μm) were mixed together in a 293:80:190 weight ratio by air-blowing and sucked in a forming bock. The mixed materials were shredded by spike rollers and lead onto a treadmill to form a mat with a thickness of around 3.5 mm and a basis weight of around 563 g/m² with a homogenous distribution of the materials. The fabric was then subjected to calendering to allow the PE-PET fibers to fuse and bind the Li₂TiO₃ powder and the PP fibers between them.

Characteristics of the Obtained Composite Material:
Fibers with a diameter of around 20 μm (measured by statistical studies of SEM images)
Basis weight of around 560 g/m²
Thickness of around 3.5 mm
Density of around 0.15 g/cm³ (calculated by measuring the weight of material comprised in a 30 mL cartridge)
Open porosity of around 90% (measured by pressure difference)
Weight distribution of 293:80:190 of lithium-adsorbent particles:polymer binder:polymer microfibers
Temperature of use range: up to 100° C.

ii—with an Autobinding PE-PP Fibers

Li₂TiO₃ powder prepared according to the above methods A or B, and PE-PP fibers (Core-Shell fibers with PE as the shell polymer, melting point of the shell at 127° C., diameter 10 μm) were mixed together in a 50:50 weight ratio by air-blowing and sucked in a forming bock. The mixed materials were shredded by spike rollers and lead onto a treadmill to form a mat with a thickness of around 3.5 mm and a basis weight of around 563 g/m² with a homogenous distribution of the materials. The mat was sandwiched between two extra layers of nonwoven fabric (Spunbond or Meltblow: polypropylene fibers, basis weight between 25 and 40 g/m²) before and then subjected to calendering to allow the PE shell to fuse and bind the Li₂TiO₃ powder and the fibers between them.

Characteristics of the Obtained Composite Material:
Fibers with a diameter of around 20 μm (measured by statistical studies of SEM images)
Basis weight of around 560 g/m²
Thickness of around 3.5 mm
Density of around 0.15 g/cm³ (calculated by measuring the weight of material comprised in a 30 mL cartridge)
Open porosity of around 90% (measured by pressure difference)
Weight distribution of 50:50 of lithium-adsorbent particles:polymer microfibers
Temperature of use range: up to 100° C.

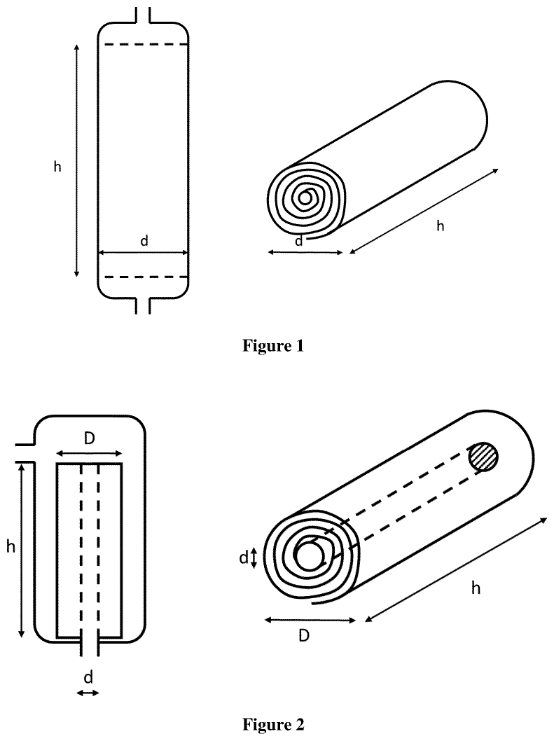

As shown in FIG. 1, the above nonwoven fabrics can be rolled up or rolled around a plastic rod into a full cylinder of the height and diameter of the empty cartridge. The obtained cylinder can be packed into the cartridge and closed on each side with a cap equipped with a water connection.

As shown in FIG. 2, the above nonwoven fabrics can also be rolled around a hollow perforated plastic cylinder with one open extremity into a hollow cylinder of the same height as the central plastic cylinder and of a given diameter. The obtained cylinder can be inserted into the cartridge and closed with an appropriate cap.

c—Powder Addition Before Core-Shell Fiber Production

Li₂TiO₃ powder prepared according to the above methods A or B, and PP powder were mixed together and extruded into a compounding material composed of 50-50 ratio of Li₂TiO₃ and PP. Using a double perpendicular extruder apparatus, a bi-composing fiber with a PP core and a Li₂TiO₃—PP shell was obtained with a total fiber diameter of 350 μm and a core of 17 μm thickness.

Characteristics of the Obtained Composite Material:
Fibers with a diameter of around 350 μm (measured by statistical studies of SEM images)
Weight distribution of 9:81 of lithium-adsorbent particles:polymer
Temperature of use range: up to 100° C.

The above free fibers can be packed into a cartridge and closed on each side with a cap equipped with a water connection.

### Example 3: Composite Material Activation, Lithium Capture and Lithium Release

Step o—Material Activation

The composite material packed in a column (1 BV or 1 Bed Volume) was treated with 10 BV of a 0.2 M hydrochloric acid solution with a flow rate of 8 BV/hour in an open circuit at room temperature to yield an acid solution containing lithium and an activated composite material.

After treatment with acid, the composite material was rinsed with 10 BV of de-ionized water with a flow rate of 8 BV/hour in an open circuit to remove acid traces from the media.

Step a—Extraction of Lithium from a Brine

i) From a Brine Containing 200 ppm of Lithium

The activated composite material was subjected to treatment with 7 BV of a brine containing 200 ppm lithium for 4 hours with a flow rate of 8 BV/hour in a closed circuit to yield a brine containing 10 to 60 ppm lithium and a lithium-loaded composite material. A pH control of the brine can be performed by adjusting pH before, or during step (a) to neutralize protons by adding small fractions, around 0.05 BV of concentrated ammonia solution (28% weight solution).

ii) From a Brine Containing 30 000 ppm Na, 4 000 ppm Ca, 50 ppm Mg, and 200 ppm of Lithium

The activated composite material was subjected to treatment with 8 BV of a brine containing 30 000 ppm Na, 4 000 ppm Ca, 50 ppm Mg, and 200 ppm of lithium for 1 hour with a flow rate of 8 BV/hour in an open circuit to yield a brine containing 10 to 15 ppm lithium before breakthrough and a lithium-loaded composite material. A pH control of the brine can be performed by adjusting pH before, or during step (a) to neutralize protons by adding small fractions, around 0.05 BV of concentrated ammonia solution (28% weight solution).

iii) From a Brine Containing 80 000 ppm Na, 100 ppm Ca, 100 ppm Mg, and 300 ppm of Lithium

The activated composite material was subjected to treatment with 8 BV of a brine containing 80 000 ppm Na, 100 ppm Ca, 100 ppm Mg, and 300 ppm of lithium for 1 hour with a flow rate of 8 BV/hour in an open circuit to yield a brine containing 10 to 15 ppm lithium before breakthrough and a lithium-loaded composite material. A pH control of the brine can be performed by adjusting pH before, or during step (a) to neutralize protons by adding small fractions, around 0.05 BV of concentrated ammonia solution (28% weight solution).

iv) From a Brine Containing 1000 ppm Na, 700 ppm Ca, 50 ppm Mg, and 50 ppm of Lithium

The activated composite material was subjected to treatment with 8 BV of a brine containing 1000 ppm Na, 700 ppm Ca, 50 ppm Mg, and 50 ppm of lithium for 1 hour with a flow rate of 8 BV/hour in an open circuit to yield a brine containing 0 to 10 ppm lithium before breakthrough and a lithium-loaded composite material. A pH control of the brine can be performed by adjusting pH before, or during step (a) to neutralize protons by adding small fractions, around 0.05 BV of concentrated ammonia solution (28% weight solution).

v) From a Brine Containing 8 000 ppm Na, 4 000 ppm Ca, 50 ppm Mg, and 300 ppm of Lithium

The activated composite material was subjected to treatment with 8 BV of a brine containing 8 000 ppm Na, 4 000 ppm Ca, 50 ppm Mg, and 300 ppm of lithium for 1 hour with a flow rate of 8 BV/hour in an open circuit to yield a brine containing 10 to 15 ppm lithium before breakthrough and a lithium-loaded composite material. A pH control of the brine can be performed by adjusting pH before, or during step (a) to neutralize protons by adding small fractions, around 0.05 BV of concentrated ammonia solution (28% weight solution).

After treatment with brine, the composite material was rinsed with de-ionized water to remove traces of brine from the media.

Steps b and c—Production of a Lithium Chloride Solution

i) After Lithium Capture from a Brine Containing 200 ppm of Lithium

The lithium-loaded composite material was treated with 10 BV of a 0.2 M hydrochloric acid solution with a flow rate of 8 BV/hour in an open circuit at room temperature to yield a solution containing lithium and a lithium-unloaded composite material.

The produced solution can be re-used with its pH adjusted thanks to small addition of concentrated HCl to increase it lithium content.

TABLE 1

| Number of (re)-use of | |
|---|---|
| the acidic solution | Lithium content (ppm) |
| 1 | 113 |
| 2 | 212 |
| 3 | 310 |
| 4 | 410 |
| 5 | 661 |
| 6 | 834 |
| 7 | 938 |
| 8 | 1060 |

ii) After Lithium Capture from a Brine Containing 30 000 ppm Na, 4 000 ppm Ca, 50 ppm Mg, and 200 ppm of Lithium

The lithium-loaded composite material was treated with 3 BV of a 0.2 M hydrochloric acid solution with a flow rate of 8 BV/hour in a closed circuit at room temperature to yield a solution containing lithium and a lithium-unloaded composite material.

The produced solution can be re-used with its pH adjusted thank to small addition of concentrated HCl to increase it lithium content.

TABLE 2

| Number of (re)-use of | |
|---|---|
| the acidic solution | Lithium content (ppm) |
| 1 | 63 |
| 2 | 138 |
| 3 | 147 |
| 4 | 172 |
| 5 | 287 |
| 6 | 309 |
| 7 | 348 |
| 8 | 383 |
| 9 | 410 |

The final solution contains 535 ppm Na, 500 ppm Ca, 15 ppm Mg, and 410 ppm of lithium. Lithium was therefore concentrated by a factor of 115 when compared to sodium.

iii) After Lithium Capture from a Brine Containing 80 000 ppm Na, 100 ppm Ca, 100 ppm Mg, and 300 ppm of Lithium

The lithium-loaded composite material was treated with 3 BV of a 0.2 M hydrochloric acid solution with a flow rate of 8 BV/hour in a closed circuit at room temperature to yield a solution containing lithium and a lithium-unloaded composite material.

The produced solution can be re-used with its pH adjusted thank to small addition of concentrated HCl to increase it lithium content.

TABLE 3

| Number of (re)-use of | |
|---|---|
| the acidic solution | Lithium content (ppm) |
| 1 | 106 |
| 2 | 163 |
| 3 | 278 |
| 4 | 340 |
| 5 | 429 |
| 6 | 574 |

The final solution contains 610 ppm Na, 15 ppm Ca, 1 ppm Mg, and 574 ppm of lithium. Lithium was therefore concentrated by a factor of 250 when compared to sodium.

iv) After Lithium Capture from a Brine Containing 1 000 ppm Na, 700 ppm Ca, 50 ppm 20 Mg, and 50 ppm of Lithium

The lithium-loaded composite material was treated with 3 BV of a 0.2 M hydrochloric acid solution with a flow rate of 8 BV/hour in a closed circuit at room temperature to yield a solution containing lithium and a lithium-unloaded composite material.

The produced solution can be re-used with its pH adjusted thank to small addition of concentrated HCl to increase it lithium content.

TABLE 4

| Number of (re)-use of | |
|---|---|
| the acidic solution | Lithium content (ppm) |
| 1 | 72 |
| 2 | 137 |
| 3 | 161 |
| 4 | 196 |
| 5 | 219 |
| 6 | 289 |
| 7 | 309 |

The final solution contains 490 ppm Na, 960 ppm Ca, 56 ppm Mg, and 309 ppm of lithium. Lithium was therefore concentrated by a factor of 13 when compared to sodium.

v) After Lithium Capture from a Brine Containing ×8 000 ppm Na, 4 000 ppm Ca, 50 ppm Mg, and 300 ppm of Lithium

The lithium-loaded composite material was treated with 3 BV of a 0.2 M hydrochloric acid solution with a flow rate of 8 BV/hour in a closed circuit at room temperature to yield a solution containing lithium and a lithium-unloaded composite material.

The produced solution can be re-used with its pH adjusted thank to small addition of concentrated HCl to increase it lithium content.

TABLE 5

| Number of (re)-use of | |
|---|---|
| the acidic solution | Lithium content (ppm) |
| 1 | 205 |
| 2 | 399 |
| 3 | 496 |
| 4 | 743 |
| 5 | 849 |
| 6 | 927 |
| 7 | 1 044 |
| 8 | 1 293 |

The final solution contains 854 ppm Na, 728 ppm Ca, 7 ppm Mg, and 1293 ppm of lithium. Lithium was therefore concentrated by a factor of 40 when compared to sodium.

After treatment with acid, the composite material was rinsed with 10 BV of de-ionized water with a flow rate of 8 BV/hour in an open circuit to remove acid traces from the media. A new cycle of capture and release can then be performed using the composite material.

1-16. (canceled)

17. A composite material comprising polymer microfibers and lithium-adsorbent particles, characterized in that:
said polymer microfibers have a diameter between 10 μm and 500 μm;
said composite material has an open porosity between 70% and 99%; and
said composite material has a density between 0.05 g/cm³ and 0.5 g/cm³.

18. The composite material according to claim 17, characterized in that said lithium-adsorbent particles are selected from the group consisting of lithium titanate, lithium aluminate, lithium manganate particles, and a mixture thereof.

19. The composite material according to claim 17, characterized in that said lithium-adsorbent particles have a mean diameter between 10 nm and 10 μm.

20. The composite material according to claim 17, characterized in that said lithium-adsorbent particles are in the form of agglomerates, said agglomerates having a size between 1 μm and 500 μm.

21. The composite material according to claim 17, characterized in that said polymer microfibers have a diameter between 50 μm and 150 μm.

22. The composite material according to claim 17, characterized in that said composite material has a density between 0.15 g/cm³ and 0.3 g/cm³.

23. The composite material according to claim 17, characterized in that the polymer of the polymer microfibers is selected from polypropylene, polystyrene, polyethylene, polyvinyl chloride, a fluoropolymer, polyvinyl alcohol, polyacrylic acid, polymethacrylic acid, polyacrylamide, polyacrylonitrile, polyether imine, polyether ketone ketone (PEKK), polyether ether ketone (PEEK), polyesters, polyamides, polysiloxane, a copolymer thereof, or a mixture thereof.

24. The composite material according to claim 17, characterized in that said composite material has an open porosity between 80% and 90%.

25. The composite material according to claim 17, characterized in that the weight ratio of said lithium-adsorbent particles to said polymer microfibers is between 0.05 and 5.

26. The composite material according to claim 17, characterized in that said composite material is in the form of a nonwoven fabric having a basis weight between 100 and 800 g/m².

27. A cartridge comprising a composite material as defined in claim 17.

28. A process for extracting lithium from a brine comprising the steps of:
(o) optionally, contacting a composite material as defined in claim 17 with an acid solution so as to obtain an activated composite material;
(a) contacting said composite material or the activated composite material of step (o) with a brine comprising lithium, so as to obtain a lithium-loaded composite material;
(b) contacting said lithium-loaded composite material obtained in step (a) with an acid solution so as to obtain a lithium-containing solution and a lithium-unloaded composite material; and
(c) separating said lithium-containing solution and said lithium-unloaded composite material obtained in step (b).

29. The process according to claim 28, characterized in that said contacting step (a) comprises flowing said brine comprising lithium through said material.

30. The process according to claim 28, characterized in that said contacting step (b) comprises flowing said acid solution through said lithium-loaded composite material.

31. The process according to claim 28, wherein said acid solution in steps (o) and (b) is an HCl aqueous solution.
